(19) United States
(12) Patent Application Publication
(10) Pub. No.: US 2019/0297613 A1
(43) Pub. Date: Sep. 26, 2019

(54) WIRELESS COMMUNICATIONS SYSTEMS SUPPORTING CARRIER AGGREGATION AND SELECTIVE DISTRIBUTED ROUTING OF SECONDARY CELL COMPONENT CARRIERS FOR SELECTIVELY DIRECTING CAPACITY

(71) Applicant: Corning Optical Communications Wireless Ltd, Airport City (IL)

(72) Inventor: Dror Harel, Hod Hasharon (IL)

(21) Appl. No.: 15/926,343

(22) Filed: Mar. 20, 2018

(51) Int. Cl. H04W 72/04; H04L 5/00; H04W 76/10

(52) U.S. Cl. CPC H04W 72/0406; H04L 1/1812; H04W 76/10; H04L 5/001

(57) ABSTRACT

Wireless communications systems which support carrier aggregation and selectively distribute routing of secondary cell component carriers to selectively direct wireless capacity are disclosed. The wireless communications system includes a signal router circuit communicatively coupled to a signal source. The signal router circuit is configured to distribute a primary cell component carrier, including control information, to each of multiple remote units to be distributed to any mobile device in a respective coverage area of any remote unit. The signal router circuit selectively distributes one or more secondary cell component to the multiple remote units to increase wireless capacity. Thus, because the control information in the primary cell component carrier is distributed to each remote unit, if a mobile device moves between different coverage areas provided by different remote units, no handover is required.

### BACKGROUND

The disclosure relates to wireless communications equipment, systems, and related networks, such as Universal Mobile Telecommunications Systems (UMTSs), its offspring Long Term Evolution (LTE) and 5th Generation New Radio (5G-NR) described and being developed by the Third Generation Partnership Project (3GPP), and more particularly to supporting carrier aggregation and selective distributed routing of secondary cell component carriers for selectively directing capacity.

Wireless customers are increasingly demanding wireless communications services, including in areas that are poorly serviced by conventional cellular networks, such as inside certain buildings or areas where there is little cellular coverage. In this regard, distributed wireless communications systems, such as distributed antenna systems (DASs), are being deployed to provide voice and data services to poorly serviced areas. A DAS generally includes remote antenna units (RAUs) configured to receive and transmit communications signals to mobile devices within the antenna range of the RAUs. A DAS can be particularly useful when deployed inside a building or other indoor environment where the wireless communications devices may not otherwise be able to effectively receive radio frequency (RF) signals from a source.

In this regard, FIG. 1 illustrates a conventional DAS 100 that is configured to distribute communications services to remote coverage areas 102(1)-102(N), where ‘N’ is the number of remote coverage areas. The DAS 100 can be configured to support cellular communications services. The remote coverage areas 102(1)-102(N) are created by and located about RAUs 104(1)-104(N) connected to a central unit 106. The central unit 106 may be communicatively coupled to a base transceiver station (BTS) 108. In this regard, the central unit 106 receives downlink communications signals 110D from the BTS 108 to be distributed to the RAUs 104(1)-104(N). The downlink communications signals 110D can include data communications signals and/or communication signaling signals on multiple frequency communications bands. The central unit 106 is configured with filtering circuits and/or other signal processing circuits that are configured to support a specific number of communications services in a particular frequency bandwidth (i.e., frequency communications bands). The downlink communications signals 110D are communicated by the central unit 106 over a communications link 112 over their frequency to the RAUs 104(1)-104(N).

With continuing reference to FIG. 1, the RAUs 104(1)-104(N) are configured to receive the downlink communications signals 110D from the central unit 106 over the communications link 112. The downlink communications signals 110D are configured to be distributed to the respective remote coverage areas 102(1)-102(N) of the RAUs 104(1)-104(N). The RAUs 104(1)-104(N) are also configured with filters and other signal processing circuits that are configured to support the communications services (i.e., frequency communications bands) supported by the central unit 106. Each of the RAUs 104(1)-104(N) includes an RF transmitter/receiver 114(1)-114(N) and a respective antenna 116(1)-116(N) operably connected to the RF transmitter/receiver 114(1)-114(N) to wirelessly distribute the communications services to user equipment 118 within the respective remote coverage areas 102(1)-102(N). The RAUs 104(1)-104(N) are also configured to receive uplink communications signals 110U from the user equipment 118 in the respective remote coverage areas 102(1)-102(N) to be distributed to the BTS 108.

The capacity of wireless communications systems, including distributed wireless communications systems, may be improved through carrier aggregation. For example, carrier aggregation is a feature of LTE-advanced and newer telecommunications systems which provides for more efficient use of capacity across a set of wireless media, such as multiple wireless spectrum frequency bands. In carrier aggregation, a component carrier refers to a communication channel used for data transmission. Multiple such component carriers may be combined for data transmission even where the component carriers may be transmitted on separate frequency bands. According to carrier aggregation, for each user equipment there is one component carrier used as a primary cell that provides control information and functions, such as Non-Access Stratum (NAS) mobility information, Radio Resource Control (RRC), and connection maintenance. In the downlink, the carrier corresponding to the primary cell is the downlink primary component carrier, while in the uplink it is the uplink primary component carrier. One or more other component carriers are referred to as secondary cells and are used for bandwidth expansion for the particular user equipment. The cell where an initial access is performed by the user equipment is the cell which is related by the network as the primary cell. Changing of a primary cell is performed only via a handover procedure. The network can configure additional component carriers as secondary cells only for a carrier aggregation-capable device with an RRC connection on a primary cell. The configuration of secondary cells is done via dedicated RRC signaling to the user equipment, as well as any addition, reconfiguration or removal of secondary cells.

Using carrier aggregation, a wireless communications system may recurrently perform activation/deactivation of the secondary cell(s) while trying to provide the necessary throughput required by the user equipment and keeping the user equipment power consumption low whenever possible. The activation/deactivation of the secondary cells is performed by the network independently for each of the secondary cells serving the user equipment, according to internal algorithms of the network (aiming, for example, to meet the user equipment's current traffic demand). Thus a handover is not required for moving between secondary cells while a primary cell is active for user equipment.

In this regard, FIG. 2 illustrates a conventional implementation of carrier aggregation with the DAS 100 of FIG. 1 that is configured to distribute communications services to remote coverage areas 102(1)-102(N) created by and located about RAUs 104(1)-104(N). According to a conventional approach, the central unit 106 transmits and receives multiple component carriers CC₁-CCₘ from the BTS 108, with each component carrier CC₁-CCₘ being transmitted and received at a different RF carrier frequency f₁-fₖ. The central unit 106 distributes all component carriers CC₁-CCₘ to all RAUs 104(1)-104(N), and the RAUs 104(1)-104(N) transmit and receive each component carrier CC₁-CCₘ wirelessly at a different RF carrier frequency f₁-fₖ. The transmitted component carriers are: a primary cell CC₁ transmitted at RF carrier frequency f₁, secondary cell CC₂ transmitted at RF carrier frequency f₂, secondary cell CC₃ transmitted at RF carrier frequency f₃, secondary cell CC₄ transmitted at RF carrier frequency f₄, and so on up to secondary cell CCₘ transmitted at RF carrier frequency fₖ. Component carriers CC₂-CCₘ are used to provide additional capacity in addition to the primary cell CC₁. Because all component carriers CC₁-CCₘ are distributed to all remote coverage areas 102(1)-102(N) of the DAS 100, no handover procedure is required for user equipment which moves between remote coverage areas 102(1)-102(N).

The additional capacity provided by the secondary cells can be projected as a capacity (e.g., units of information per unit time) over the covered area. Referring to FIG. 2, the capacity of an m^{th} component carrier may be represented as C(CCₘ), and a total area of all coverage areas 102(1)-102(N) may be represented as a value A. As an example, the DAS 100 in FIG. 2 may include four secondary cell component carriers (CC₂, CC₃, CC₄, CC₅). The total capacity of the secondary cells of the DAS 100 may then be represented as the sum of the capacity of the secondary cell component carriers CC₂-CC₅. If it is further assumed that the capacity of each secondary cell is equal to a value C [C(CC₂)=C(CC₃)=C(CC₄)=C(CC₅)=C], the total capacity per area of the DAS 100 is equal to:

$$Capacity per area = \frac{C ( {CC}_{2} ) + C ( {CC}_{3} ) + C ( {CC}_{4} ) + C ( {CC}_{5} )}{A} = \frac{4 C}{A} .$$

No admission is made that any reference cited herein constitutes prior art. Applicant reserves the right to challenge the accuracy and pertinency of any cited documents.

### SUMMARY

Embodiments disclosed herein include wireless communications systems which support carrier aggregation and selectively distribute routing of secondary cell component carriers to selectively direct wireless capacity. Related systems and methods are also disclosed herein. As an example, a wireless communications system that supports carrier aggregation and selective distributed routing of secondary cell component carriers can include a distributed wireless communications system, such as a distributed antenna system (DAS). In an exemplary aspect disclosed herein, the wireless communications system includes a signal router circuit communicatively coupled to one or more signal sources. The signal router circuit is configured to receive component carriers (e.g., communication channels used for data transmission) from the signal source(s) and distribute the component carriers. In one example, the component carriers received and distributed by the signal router circuit are in baseband. The signal router circuit distributes a primary cell component carrier, which provides control information, and one or more secondary cell component carriers to a remote unit, which increase downlink and/or uplink capacity that can be provided through the remote unit. The signal router circuit routes the primary cell component carrier received from the signal source to each of the remote units so that the primary cell component carrier is distributed to any mobile device in a respective coverage area of any remote unit. Because the control information in the primary cell component carrier is thus distributed to each remote unit, if a mobile device moves between different coverage areas provided by different remote units, no handover procedure is required.

In addition, the signal router circuit is configured to selectively distribute secondary cell component carrier(s) to the remote units. With the primary cell component carrier and its control information distributed to each remote unit, the secondary cell component carrier(s) do not need to be indiscriminately distributed to each remote unit. Secondary cell component carriers can instead be routed to only one or a subset of the remote units. For example, the signal router circuit can route secondary cell component carriers to remote units that may have a need to support a larger number of mobile devices to increase capacity over other remote units with fewer mobile devices. As another example, the signal router circuit can route a first secondary cell component carrier to a first remote unit and a second secondary cell component carrier to a second remote unit. Where the first remote unit and the second remote unit have non-overlapping coverage areas, each of the first secondary cell component carrier and the second secondary cell component carrier may be transmitted and/or received within a common wireless channel, enabling the coverage areas of each remote unit to have additional capacity with less usage of spectrum.

One embodiment of the disclosure relates to a distributed wireless communications system. The distributed wireless communications system includes a signal router circuit which comprises a plurality of signal source inputs each configured to receive a component carrier among a plurality of component carriers. The plurality of component carriers includes a primary cell component carrier, a first secondary cell component carrier, and a second secondary cell component carrier. The signal router circuit also comprises a plurality of signal outputs each configured to couple to a remote unit among a plurality of remote units. The signal router circuit also comprises a routing control input configured to receive a routing control signal for routing the primary cell component carrier, the first secondary cell component carrier, and the second secondary cell component carrier to the plurality of signal outputs. The distributed wireless communications system further includes a controller circuit comprising a routing control output coupled to the routing control input. The controller circuit is configured to communicate the routing control signal indicating the routing configuration for routing the primary cell component carrier to each of the plurality of signal outputs, routing the first secondary cell component carrier to a first subset of the plurality of signal outputs less than all of the plurality of signal outputs, and routing the second secondary cell component carrier to a second subset of the plurality of signal outputs less than all of the plurality of signal outputs. The first subset of the plurality of signal outputs includes at least one signal output not included in the second subset of the plurality of signal outputs.

An additional embodiment of the disclosure relates to a method for selectively routing primary cell and secondary cell component carriers from one or more signal source circuits to a plurality of remote units in a distributed wireless communications system. The method includes the steps of receiving a primary cell component carrier, receiving a first secondary cell component carrier, and receiving a second secondary cell component carrier. The method further includes the steps of routing the primary cell component carrier to each of the plurality of remote units, routing the first secondary cell component carrier to a first remote unit and not to a second remote unit of the plurality of remote units, and routing the second secondary cell component carrier to the second remote unit.

Additional features and advantages will be set forth in the detailed description which follows, and in part will be readily apparent to those skilled in the art from that description or recognized by practicing the embodiments as described herein, including the detailed description which follows, the claims, as well as the appended drawings.

It is to be understood that both the foregoing general description and the following detailed description are merely exemplary, and are intended to provide an overview or framework to understanding the nature and character of the claims. The accompanying drawings are included to provide a further understanding, and are incorporated in and constitute a part of this specification. The drawings illustrate one or more embodiment(s), and together with the description serve to explain principles and operation of the various embodiments.

### BRIEF DESCRIPTION OF THE DRAWINGS

FIG. 1 is a schematic diagram of a conventional distributed antenna system (DAS) that is configured to distribute communications services to remote coverage areas;

FIG. 2 is a schematic diagram of the conventional DAS of FIG. 1 distributing multiple component carriers in a carrier aggregation scheme;

FIG. 3 is a schematic diagram of an exemplary distributed wireless communications system supporting carrier aggregation and employing selective distributed routing of secondary cell component carriers for selectively directing capacity;

FIG. 4 is a schematic diagram of the exemplary distributed wireless communications system of FIG. 3 selectively routing secondary cell component carriers;

FIG. 5 is a chart illustrating an example of deactivation and activation of secondary cell component carriers for a mobile device moving between coverage areas of different remote units;

FIG. 6 is a chart illustrating another example of deactivation and activation of secondary cell component carriers for a mobile device moving between coverage areas of different remote units;

FIG. 7 is a flowchart illustrating an exemplary process of a signal router circuit in the distributed wireless communications system in FIGS. 3 and 4 supporting carrier aggregation and selectively routing secondary cell component carriers to the one or more remote units;

FIG. 8 is a partially schematic cut-away diagram of an exemplary building infrastructure in which the distributed wireless communications system of FIG. 3 can be provided;

FIG. 9 is a schematic diagram illustrating a computer system that could be employed in any component in the distributed wireless communications system in FIGS. 3-8, including but not limited to the controller circuit, for selectively routing secondary cell component carriers to the remote units; and

FIG. 10 is a schematic diagram illustrating an exemplary downlink user plane protocol stack for carrier aggregation and a corresponding mapping of some radio resource management functionalities, some or all of which may be implemented in the distributed wireless communications system of FIG. 3, such as through the signal source circuit.

### DETAILED DESCRIPTION

Reference will now be made in detail to the present preferred embodiment(s), an examples of which is/are illustrated in the accompanying drawings. Whenever possible, the same reference numerals will be used throughout the drawings to refer to the same or like parts.

Embodiments disclosed herein include wireless communications systems which support carrier aggregation and selectively distribute routing of secondary cell component carriers to selectively direct wireless capacity. Related systems and methods are also disclosed herein. As an example, a wireless communications system that supports carrier aggregation and selective distributed routing of secondary cell component carriers can include a distributed wireless communications system, such as a distributed antenna system (DAS). In an exemplary aspect disclosed herein, the wireless communications system includes a signal router circuit communicatively coupled to one or more signal sources. The signal router circuit is configured to receive component carriers (e.g., communication channels used for data transmission) from the signal source(s) and distribute the component carriers. In one example, the component carriers received and distributed by the signal router circuit are in baseband. The signal router circuit distributes a primary cell component carrier, which provides control information, and one or more secondary cell component carriers to a remote unit, which increase downlink and/or uplink capacity that can be provided through the remote unit. The signal router circuit routes the primary cell component carrier received from the signal source to each of the remote units so that the primary cell component carrier is distributed to any mobile device in a respective coverage area of any remote unit. Because the control information in the primary cell component carrier is thus distributed to each remote unit, if a mobile device moves between different coverage areas provided by different remote units, no handover procedure is required.

In addition, the signal router circuit is configured to selectively distribute secondary cell component carrier(s) to the remote units. With the primary cell component carrier and its control information distributed to each remote unit, the secondary cell component carrier(s) do not need to be indiscriminately distributed to each remote unit. Secondary cell component carriers can instead be routed to only one or a subset of the remote units. For example, the signal router circuit can route secondary cell component carriers to remote units that may have a need to support a larger number of mobile devices to increase capacity over other remote units with fewer mobile devices. As another example, the signal router circuit can route a first secondary cell component carrier to a first remote unit and a second secondary cell component carrier to a second remote unit. Where the first remote unit and the second remote unit have non-overlapping coverage areas (or any interference therebetween will be otherwise tolerable), each of the first secondary cell component carrier and the second secondary cell component carrier may be transmitted and/or received within a common wireless channel, enabling the coverage areas of each remote unit to have additional capacity with less usage of spectrum.

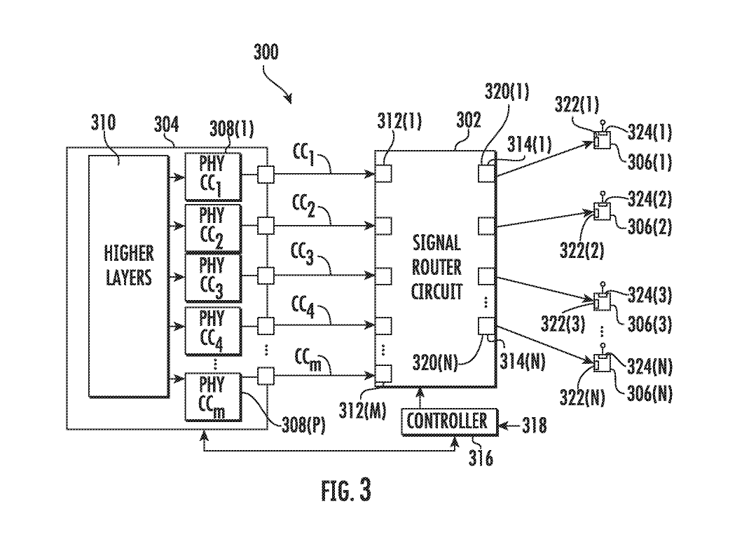

In this regard, FIG. 3 illustrates an exemplary distributed wireless communications system 300 supporting carrier aggregation and employing selective distributed routing of secondary cell component carriers for selectively directing capacity. The distributed wireless communications system 300 includes a signal router circuit 302 communicatively coupled to one or more signal source circuits 304. The signal router circuit 302 is configured to receive component carriers CC₁-CCₘ from the signal source circuit 304 and distribute the component carriers CC₁-CCₘ. The notation “1-m” indicates that any number of component carriers, 1-m, may be provided. The signal router circuit 302 distributes a primary cell component carrier CC₁ and one or more secondary cell component carriers CC₂-CCₘ to one or more remote units 306(1)-306(N), where ‘N’ is the number of remote units.

A component carrier CC₁-CCₘ refers to a communication channel used for data transmission, which may include uplink and/or downlink components. Accordingly, while the signal router circuit 302 is described as “receiving” component carriers CC₁-CCₘ which are “distributed” to the remote units 306(1)-306(N), for each component carrier CC₁-CCₘ an uplink (transmitting information from a mobile device to a telecommunications network) and/or a downlink (transmitting information from the telecommunications network to the mobile device) may be formed between the signal router circuit 302 and the signal source circuit 304, as well as between the signal router circuit 302 and a remote unit 306(1)-306(N). For each mobile device supported by carrier aggregation in a communications system that supports carrier aggregation, there is one component carrier used as a primary cell that provides control information and functions, such as Non-Access Stratum (NAS) mobility information, Radio Resource Control (RRC), and connection maintenance. In the example depicted in FIG. 3, component carrier CC₁ received from the signal source circuit 304 is a primary cell component carrier. The additional component carriers CC₂-CCₘ received from the signal source circuit 304 are secondary cell component carriers, selectively used for bandwidth expansion for mobile devices in communication with the distributed wireless communications system 300.

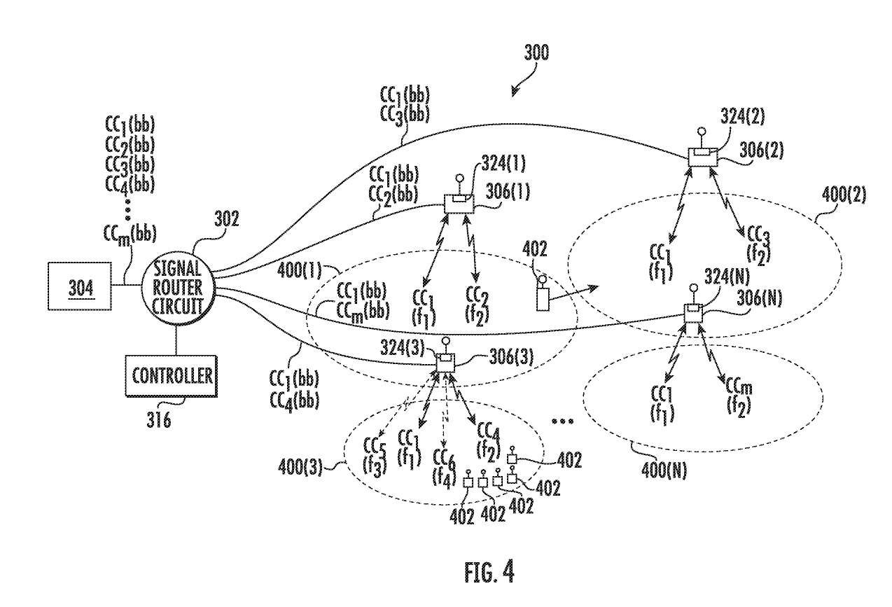

The signal router circuit 302 routes the primary cell component carrier CC₁ received from the signal source circuit 304 to each of the remote units 306(1)-306(N) so that the primary cell component carrier CC₁ is distributed to any mobile device in a respective coverage area of any remote unit 306(1)-306(N). Because the control information in the primary cell component carrier CC₁ is thus distributed to each remote unit 306(1)-306(N), if a mobile device moves between different coverage areas provided by different remote units, no handover procedure is required. In addition, the signal router circuit 302 is configured to selectively distribute secondary cell component carrier(s) CC₂-CCₘ to the remote units 306(1)-306(N). With the primary cell component carrier CC₁ and its control information distributed to each remote unit 306(1)-306(N), the secondary cell component carrier(s) CC₂-CCₘ do not need to be indiscriminately distributed to each remote unit 306(1)-306(N). Secondary cell component carriers CC₂-CCₘ can instead be routed to only one or a subset of the remote units 306(1)-306(N), such as described further below with respect to FIG. 4.

The distributed wireless communications system 300 can be configured to support cellular communications services. In some embodiments, the signal source circuit 304 in the distributed wireless communications system 300 may include some or all functions of a base transceiver station implementing carrier aggregation functionality. For example, the signal source circuit 304 may transmit and receive communications, such as packetized data, from a telecommunications network. The signal source circuit 304 includes one or more physical layer (PHY) processing circuits 308(1)-308(P). The notation “1-P” indicates that any number of the PHY processing circuits, 1-P, may be provided. A PHY processing circuit 308(1)-308(P) couples a link layer device, such as the signal source circuit 304, to a physical medium, such as copper or optical fiber cables connected to the signal router circuit 302. In this manner, each PHY processing circuit 308(1)-308(P) can generate digital signals representing a downlink baseband signal (or another appropriate non-modulated signal) of a corresponding component carrier. A first PHY processing circuit 308(1) generates the primary cell component carrier CC₁, and the other PHY processing circuits 308(2)-308(P) generate the secondary cell component carrier signals CC₂-CCₘ.

The PHY processing circuits 308(1)-308(P) may receive data to be transmitted from higher layer processing circuit(s) 310 of the signal source circuit 304. In some examples, the higher layer processing circuits 310 include scheduling the data for each component carrier CC₁-CCₘ to be transmitted to the signal router circuit 302 by the corresponding PHY processing circuit 308(1)-308(P). Each PHY processing circuit 308(1)-308(P) may further process uplink baseband signals received from the signal router circuit 302. It should be understood that in some embodiments, some of the functions and/or circuitry of the signal source circuit 304 may reside at the remote units 306(1)-306(N). For example, the PHY processing circuits 308(1)-308(P) may be split between the signal source circuit 304 and the remote units 306(1)-306(N) where higher level portions of the PHY processing circuits 308(1)-308(P) reside at the signal source circuit 304 and lower level portions of the PHY processing circuits 308(1)-308(P) reside at the remote units 306(1)-306(N). In other embodiments, the complete PHY processing circuits 308(1)-308(P) may reside at the remote units 306(1)-306(N).

With continuing reference to FIG. 3, the signal router circuit 302 routes the component carrier(s) CC₁-CCₘ to the one or more remote units 306(1)-306(N). The signal router circuit 302 includes a plurality of signal source inputs 312(1)-312(M), each of which receives a component carrier CC₁-CCₘ from the signal source circuit 304. The signal source inputs 312(1)-312(M) may be any appropriate inputs, such as parallel input ports, serially received inputs, and so on. Generally, each signal source input 312(1)-312(M) is coupled to a corresponding PHY processing circuit 308(1)-308(P). The component carriers CC₁-CCₘ are distributed to the respective coverage areas of the remote units 306(1)-306(N) according to a routing configuration of the signal router circuit 302. The routing configuration selectively directs the routing of the component carriers CC₁-CCₘ from the signal source inputs 312(1)-312(M) of the signal router circuit 302 to a plurality of signal outputs 314(1)-314(N) of the signal router circuit 302, each of which is coupled to at least one of the plurality of remote units 306(1)-306(N).

A controller circuit 316 communicates a routing control signal to the signal router circuit 302 indicating the routing configuration for the component carriers CC₁-CCₘ from the signal source inputs 312(1)-312(M) to the signal outputs 314(1)-314(N). The controller circuit 316 may be a processor, such as a microprocessor, digital controller, microcontroller, or state machine. The controller circuit 316 may also be implemented as a combination of computing devices (e.g., a combination of a DSP and a microprocessor, a plurality of microprocessors, one or more microprocessors in conjunction with a DSP core, or any other such configuration). The routing configuration communicated by the controller circuit 316 may be based on inputs received from the signal source circuit 304 and/or additional inputs 318, which may be manual inputs or communications received from a building control device or other network management systems. An exemplary routing configuration is described further below with respect to FIG. 4. Through the routing control signal, the controller circuit 316 controls the signal router circuit 302 for determining how many component carriers CC₁-CCₘ will be used and to which remote unit(s) 306(1)-306(N) each component carrier CC₁-CCₘ will be routed. In some embodiments, the controller circuit 316 may also control at least some functions and/or circuitry of the signal source circuit 304. The controller circuit 316 may be implemented with logical circuitry and may be a standalone device, form part of another device (e.g., the signal router circuit 302, the signal source circuit 304, or a building control device), or portions of the controller circuit 316 functions and/or circuitry may reside within multiple devices (e.g., in the signal router circuit 302 or the signal source circuit 304). In some embodiments, the signal source circuit 304 may be omitted, and the signal router circuit 302 and controller circuit 316 may interface directly with an analog base station. A component carrier in such embodiments may be received at baseband or at a radio frequency (RF) carrier frequency. In this case, the signal router circuit 302 will include sampling and digitization circuitry to convert the RF component carrier signal to a baseband signal for routing to the remote unit(s) 306(1)-306(N).

With continuing reference to FIG. 3, some embodiments of the distributed wireless communications system 300 distribute the component carriers CC₁-CCₘ over optical communications media. In an exemplary embodiment, each signal output 314(1)-314(N) of the signal router circuit 302 includes an electrical-to-optical (E-O) converter 320(1)-320(N) configured to convert an electrical communications signal of the respective component carrier(s) CC₁-CCₘ into a respective optical communications signal. The respective optical communications signals are transported to the remote units 306(1)-306(N) by an optical fiber communications link coupled between each signal output 314(1)-314(N) of the signal router circuit 302 and the corresponding remote unit 306(1)-306(N). Each remote unit 306(1)-306(N) includes an optical-to-electrical (O-E) converter 322(1)-322(N) configured to convert the respective optical communications signal for the component carrier(s) CC₁-CCₘ back into the electrical communications signal to interface with an RF transmitter/receiver 324(1)-324(N) of the remote unit 306(1)-306(N). Using the electrical communications signal, each RF transmitter/receiver 324(1)-324(N) wirelessly distributes the component carriers CC₁-CCₘ to any mobile device within the coverage area of the remote unit 306(1)-306(N).

In this exemplary embodiment, the distributed wireless communications system 300 has been described to “distribute” component carriers CC₁-CCₘ. As previously discussed, it should be understood that each component carrier CC₁-CCₘ may include uplink and/or downlink components. Accordingly, the E-O converter 320(1)-320(N) of each PHY processing circuit 308(1)-308(P) may convert a downlink for each component carrier CC₁-CCₘ from electrical to optical and an uplink for each component carrier CC₁-CCₘ from optical to electrical. Similarly, the O-E converter 322(1)-322(N) of each remote unit 306(1)-306(N) may convert a downlink for each component carrier CC₁-CCₘ from optical to electrical and an uplink for each component carrier CC₁-CCₘ from electrical to optical. In addition, each optical fiber communications link may have a separate uplink and downlink medium, or may be a common optical fiber communications link. For example, wave division multiplexing (WDM) may be employed to carry the downlink optical communications signals and the uplink optical communications signals on the same optical fiber communications link.

Turning to FIG. 4, the operation and advantages of selectively distributing secondary cell component carriers CC₂-CCₘ to the remote units 306(1)-306(N) are illustrated. FIG. 4 is a schematic diagram of the exemplary distributed wireless communications system 300 of FIG. 3 selectively routing secondary cell component carriers CC₂-CCₘ. With the primary cell component carrier CC₁ and its control information distributed to each remote unit 306(1)-306(N), the secondary cell component carriers CC₂-CCₘ can be routed to only one or a subset of the remote units 306(1)-306(N). The distributed wireless communications system 300 is configured to support carrier aggregation and selectively distribute secondary cell component carriers CC₂-CCₘ to remote coverage areas 400(1)-400(N) created by and located about the remote units 306(1)-306(N). In an exemplary aspect, the signal router circuit 302 is configured to receive component carriers CC₁-CCₘ from the signal source circuit 304 and distribute the component carriers CC₁-CCₘ to the remote units 306(1)-306(N). The signal router circuit 302 distributes a primary cell component carrier CC₁, which provides control information, and one or more secondary cell component carriers CC₂-CCₘ to a remote unit 306(1)-306(N), which increase downlink and/or uplink capacity that can be provided through the remote unit 306(1)-306(N).

The signal router circuit 302 routes the primary cell component carrier CC₁ received from the signal source circuit 304 to each of the remote units 306(1)-306(N) so that the primary cell component carrier CC₁ is distributed to any mobile device 402 in a respective coverage area 400(1)-400(N) of any remote unit 306(1)-306(N). In addition, the signal router circuit 302 is configured to selectively distribute secondary cell component carrier(s) CC₂-CCₘ to the remote units 306(1)-306(N) according to a routing configuration received from the controller circuit 316.

In the example depicted, the component carriers CC₁-CCₘ are received and distributed by the signal router circuit 302 in baseband, notated “bb.” Each remote unit 306(1)-306(N) includes one or more RF transmitter/receivers 324(1)-324(N), which include circuitry for outputting modulated RF component carrier signals based on a received component carrier baseband signal. In this regard, a first remote unit 306(1) receives the primary cell component carrier CC₁ and a first secondary cell component carrier CC₂ in baseband from the signal router circuit 302. The primary cell component carrier CC₁ is transmitted and received by the first remote unit 306(1) on a first wireless channel (e.g., RF carrier frequency) f₁, which may be a common wireless channel for the primary cell component carrier CC₁ on all remote units 306(1)-306(N). The first secondary cell component carrier CC₂ is transmitted and/or received by the first remote unit 306(1) on a second wireless channel (e.g., RF carrier frequency) f₂. The first remote unit 306(1) may support additional component carriers as needed, with each being transmitted and/or received over an additional RF carrier frequency.

Similarly, in the example depicted, a second remote unit 306(2) receives the primary cell component carrier CC₁ and a second secondary cell component carrier CC₃ in baseband from the signal router circuit 302. The primary cell component carrier CC₁ is transmitted and received by the second remote unit 306(2) on the dedicated first RF carrier frequency f₁. The second secondary cell component carrier CC₃ is transmitted and/or received by the second remote unit 306(2) on the second RF carrier frequency f₂, as directed by the signal router circuit 302 and/or the controller circuit 316. Because the primary cell component carrier CC₁ is transmitted over the dedicated RF carrier frequency f₁ by each remote unit 306(1)-306(N), in some embodiments the PHY processing circuit 308(1) may transmit the primary cell component carrier CC₁ in baseband along with signaling indicating its wireless channel frequency. Generally, the PHY processing circuits 308(2)-308(P) transmit the secondary cell component carriers CC₂-CCₘ in baseband, with the signal router circuit 302 signaling to each remote unit 306(1)-306(N) the corresponding wireless channel frequency for each secondary cell component carrier CC₂-CCₘ (e.g., according to instructions and/or signaling received from the controller circuit 316).

Because the primary cell component carrier CC₁ is distributed to each remote unit 306(1)-306(N) in this manner, the control information in the primary cell component carrier CC₁ appears at each remote unit 306(1)-306(N). Accordingly, if a mobile device 402 moves between different coverage areas 400(1)-400(N) provided by different remote units 306(1)-306(N), no handover procedure is required. In addition, the secondary cell component carrier(s) CC₂-CCₘ do not need to be indiscriminately distributed to each remote unit 306(1)-306(N), but can instead be routed to only one or a subset of the remote units 306(1)-306(N) with the primary cell component carrier CC₁ being used for control signaling to establish connections with the secondary cell component carriers CC₂-CCₘ. For example, the mobile device 402 depicted in FIG. 4 may move from a first coverage area 400(1) corresponding to the first remote unit 306(1), to a second coverage area 400(2) corresponding to the second remote unit 306(2). The mobile device 402 maintains its connection with the primary cell component carrier CC₁ as it moves from the first coverage area 400(1) to the second coverage area 400(2). The first secondary cell component carrier CC₂ is not available in the second coverage area 400(2), and the mobile device 402 therefore drops its connection to the first secondary cell component carrier CC₂ as the mobile device 402 moves into the second coverage area 400(2). However, because the second secondary cell component carrier CC₃ is available in the second coverage area 400(2), the mobile device 402 may establish a connection to the second secondary cell component carrier CC₃ (e.g., through control signaling over the primary cell component carrier CC₁) for additional capacity.

As described above, the secondary cell component carrier(s) CC₂-CCₘ can be selectively routed to only one or a subset of the remote units 306(1)-306(N). Selective routing of the secondary cell component carriers CC₂-CCₘ enables the signal router circuit 302 to route secondary cell component carriers CC₂-CCₘ to remote units 306(1)-306(N) that may have a need to support a larger number of mobile devices 402 to increase capacity over other remote units 306(1)-306(N) with fewer mobile devices 402. For example, a third remote unit 306(3) may support a larger number of mobile devices 402 within a third coverage area 400(3) than the first remote unit 306(1) within the first coverage area 400(1). As illustrated, the signal router circuit 302 initially routes the primary cell component carrier CC₁ (to be transmitted and received over the first RF carrier frequency f₁) and the first secondary cell component carrier CC₂ (to be transmitted and received over the second RF carrier frequency f₂) to the first remote unit 306(1), and also routes the primary cell component carrier CC₁ (to be transmitted and received over the first RF carrier frequency f₁) and a third secondary cell component carrier CC₄ (to be transmitted and received over the second RF carrier frequency f₂) to the third remote unit 306(3). As additional mobile devices 402 establish connections with the distributed wireless communications system 300 through the third remote unit 306(3), the controller circuit 316 may determine that more secondary cell component carriers are needed and route additional component carrier CC₅ (to be transmitted and received over a third RF carrier frequency f₃) and additional component carrier CC₆ (to be transmitted and received over a fourth RF carrier frequency f₄) to the third remote unit 306(3).

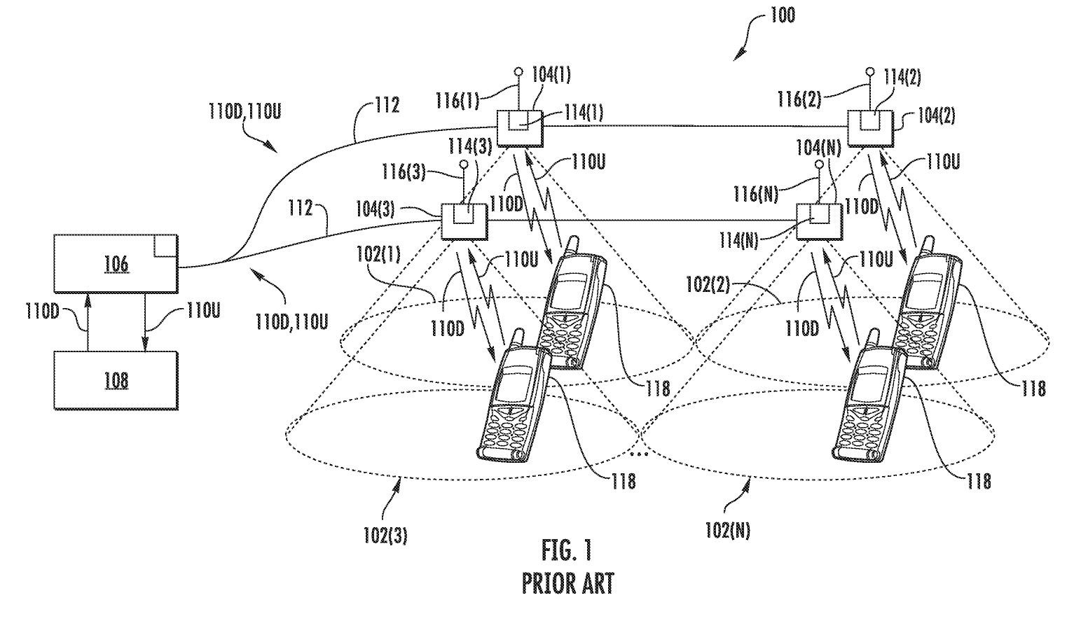

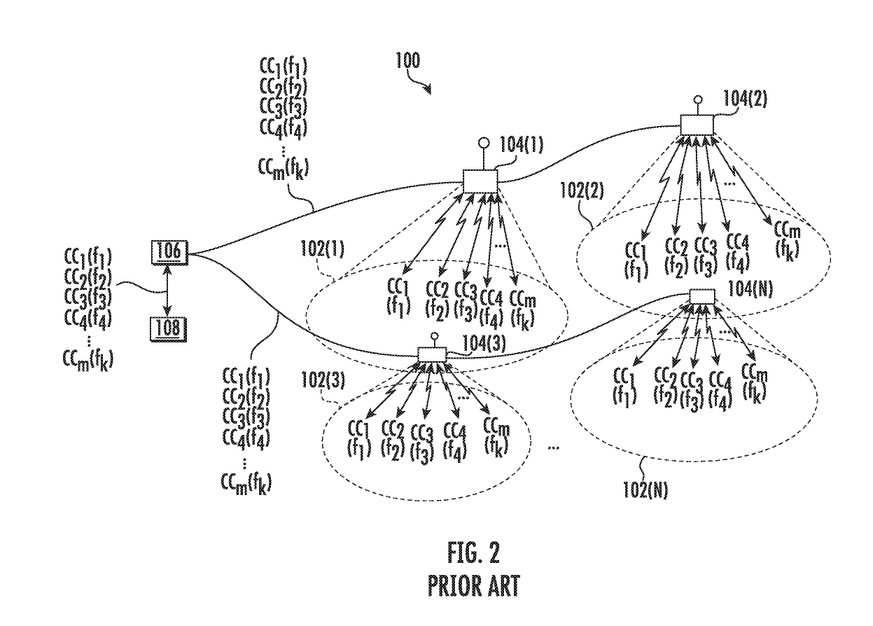

Selective routing of the secondary cell component carriers CC₂-CCₘ further enables the distributed wireless communications system 300 to conserve and reuse wireless spectrum for secondary cells in order to maintain the same capacity as the conventional DAS 100 depicted in FIGS. 1 and 2 with fewer wireless channels, or to increase the capacity using the same number of wireless channels. For example, the signal router circuit 302 can route the first secondary cell component carrier CC₂ to the first remote unit 306(1), the second secondary cell component carrier CC₃ to the second remote unit 306(2), the third secondary cell component carrier CC₄ to the third remote unit 306(3), and the fourth secondary cell component carrier CC₅ to a fourth remote unit 306(4). In this example, the coverage area 400(1)-400(4) of each of the remote units 306(1)-306(4) is substantially non-overlapping (e.g., signals carried on the same RF carrier frequency will be substantially non-interfering between coverage areas 400(1)-400(4)). Each of the secondary cell component carriers CC₂-CC₅ is transmitted and/or received within a common wireless channel (e.g., RF carrier frequency) f₂.

The additional capacity provided by the secondary cells of the distributed wireless communications system 300 depicted in FIG. 4 can be projected as a sum of the capacity per area of each secondary cell component carrier CC₂-CC₅. A total area of all coverage areas 400(1)-400(4) may be represented as a value A, and the area of each coverage area 400(1)-400(4) may be represented as a value A/4. The capacity of the m^{th} secondary cell of the distributed wireless communications system 300 may be represented as C(CCₘ). If it is further assumed that the capacity of each secondary cell is equal to a value C [C(CC₂)=C(CC₃)=C(CC₄)=C(CC₅)=C], the total capacity per area of the distributed wireless communications system 300 is equal to:

$$Capacity per area = \frac{C ( {CC}_{2} )}{A / 4} + \frac{C ( {CC}_{3} )}{A / 4} + \frac{C ( {CC}_{4} )}{A / 4} + \frac{C ( {CC}_{5} )}{A / 4} = \frac{4 C}{A} .$$

Thus, the capacity per area of the secondary cell component carriers CC₂-CC₅ in the distributed wireless communications system 300 depicted in FIG. 4 is equal to the capacity of the secondary cell component carriers CC₂-CC₅ in the DAS 100 described above with respect to FIG. 2. However, due to carrier frequency reuse, only one RF carrier frequency f₂ has been used for the secondary cell component carriers CC₂-CC₅ in the distributed wireless communications system 300 depicted in FIG. 4, rather than the four RF carrier frequencies f₂-f₅ used in the DAS 100 depicted in FIG. 2.

In some embodiments, the signal router circuit 302 may receive more than one primary cell component carrier, with the different primary cell component carriers being routed to groups of the remote units 306(1)-306(N). For example, a first primary cell component carrier CC₁ may be routed to a first subset of the remote units 306(1)-306(3) (e.g., over a first set of signal outputs 314(1)-314(3) of the signal router circuit 302), which may be located within a first region. A second primary cell component carrier CC₂ may be routed to a second subset of the remote units 306(4)-306(N) (e.g., over a second set of signal outputs 314(4)-314(N) of the signal router circuit 302), which may be located within a second region. In this regard, each primary cell component carrier CC₁, CC₂ may be associated with a group of secondary cell component carriers CC₃-CCₘ to expand the capacity of the distributed wireless communications system 300 within each region. Thus, the signal router circuit 302 in such embodiments selectively routes a first set of secondary cell component carriers CC₁-CCᵢ to the first subset of the remote units 306(1)-306(3), and selectively routes a second set of secondary cell component carriers CCᵢ₊₁-CCₘ to the second subset of the remote units 306(4)-306(N) in a similar manner as described above.

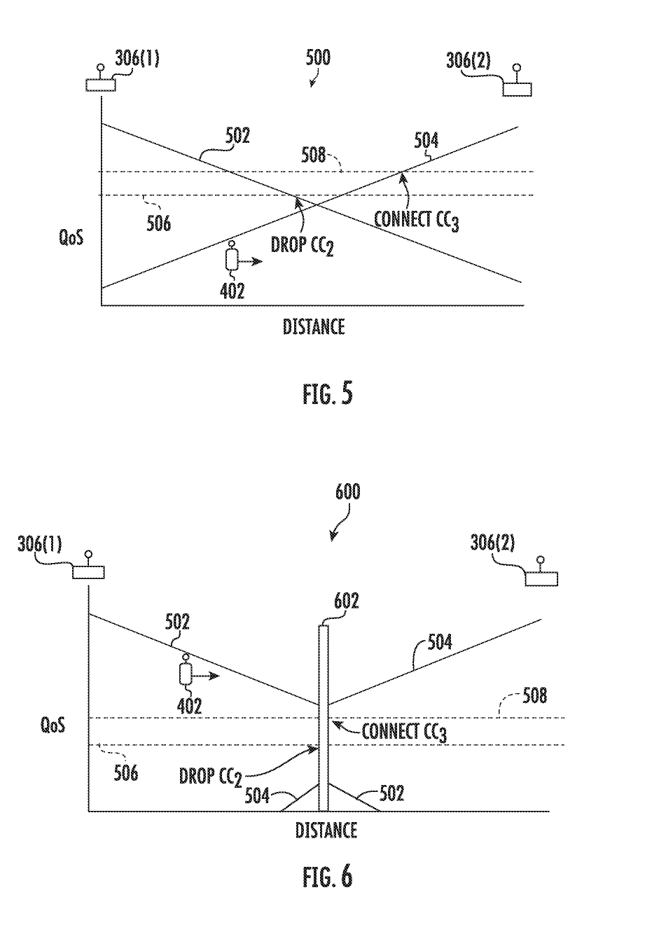

FIG. 5 is a chart 500 illustrating an example of deactivation and activation of secondary cell component carriers CC₂-CCₘ for a mobile device 402 moving between coverage areas 400(1)-400(N) of different remote units 306(1)-306(N). Referring to FIG. 4, the chart 500 illustrates a mobile device 402 moving from the first coverage area 400(1) of the first remote unit 306(1) to the second coverage area 400(2) of the second remote unit 306(2). The chart 500 of FIG. 5 illustrates a quality of service (QoS) level 502 of the first secondary cell component carrier CC₂ transmitted and/or received by the first remote unit 306(1). The chart 500 further illustrates a QoS level 504 of a second secondary cell component carrier CC₃ transmitted and/or received by the second remote unit 306(2).

When a mobile device 402 moves from the first coverage area 400(1) of the first remote unit 306(1) to the second coverage area 400(2) of the second remote unit 306(2), higher layer processing circuits 310 within the distributed wireless communications system 300 (e.g., at the signal source circuit 304, a base transceiver station, or elsewhere, see FIG. 3) detect that the QoS level 502 of the first secondary cell component carrier CC₂ is decreasing. When the QoS level 502 passes below a first threshold 506, the higher layer processing circuits 310 disconnect the mobile device 402 from the first secondary cell component carrier CC₂ (e.g., deactivate the first secondary cell component carrier CC₂ for the mobile device 402). As the mobile device 402 continues to move into the second coverage area 400(2) of the second remote unit 306(2), the higher layer processing circuits 310 detect that the QoS level 504 of the second secondary cell component carrier CC₃ is increasing. When the QoS level 504 exceeds a second threshold 508, the higher layer processing circuits 310 connect the mobile device 402 to the second secondary cell component carrier CC₃ (e.g., activate the second secondary cell component carrier CC₃ for the mobile device 402). During this process, the connection to the primary cell component carrier CC₁ is maintained.

FIG. 5 depicts the first threshold 506 for maintaining a connection to the first secondary cell component carrier CC₂ as being at a QoS level below the second threshold 508 for establishing a connection to the second secondary cell component carrier CC₃. It should be understood, however, that the relative levels of the first threshold 506 for maintaining a connection may in other embodiments be equal to or above the second threshold 508 for establishing a connection, and that the first threshold 506 and second threshold 508 may be set differently for different component carriers CC₂-CCₘ. In addition, the higher layer processing circuits 310 in FIG. 5 disconnect the mobile device 402 from the first secondary cell component carrier CC₂ before establishing a connection to the second secondary cell component carrier CC₃. It should further be understood that in other embodiments, the higher layer processing circuits 310 may instead establish a connection to the second secondary cell component carrier CC₃ at a same time or before disconnecting the mobile device 402 from the first secondary cell component carrier CC₂.

For example, FIG. 6 is a chart 600 illustrating another example of deactivation and activation of secondary cell component carriers CC₂-CCₘ for a mobile device 402 moving between coverage areas 400(1)-400(N) of different remote units 306(1)-306(N), similar to FIG. 5. In FIG. 6, a wall 602 substantially isolates the first coverage area 400(1) of the first remote unit 306(1) from the second coverage area 400(2) of the second remote unit 306(2). The wall 602 may be an appropriate device, such as a physical shield or other barrier, which substantially blocks RF signals from passing between the coverage areas 400(1) and 400(2). Accordingly, when the mobile device 402 moves through the wall 602 from the first coverage area 400(1) of the first remote unit 306(1) to the second coverage area 400(2) of the second remote unit 306(2), the higher layer processing circuits 310 detect that the QoS level 502 of the first secondary cell component carrier CC₂ has decreased below the first threshold 506 and the QoS level 504 of the second secondary cell component carrier CC₃ has increased above the second threshold 508. The higher layer processing circuits 310 simultaneously or near simultaneously disconnect the mobile device 402 from the first secondary cell component carrier CC₂ and connect the mobile device 402 to the second secondary cell component carrier CC₃. During this process, the connection to the primary cell component carrier CC₁ is maintained.

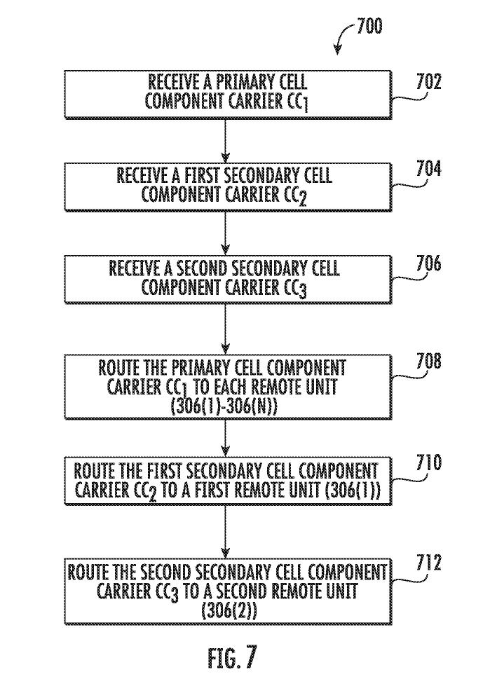

FIG. 7 is a flowchart illustrating an exemplary process 700 of the signal router circuit 302 in the distributed wireless communications system 300 in FIGS. 3 and 4 supporting carrier aggregation and selectively routing secondary cell component carriers CC₂-CCₘ to the one or more remote units 306(1)-306(N). As shown in the exemplary process 700 in FIG. 7 referencing the distributed wireless communications system 300 in FIGS. 3 and 4, the signal router circuit 302 receives a primary cell component carrier CC₁ from the signal source circuit 304 to be distributed to the remote units 306(1)-306(N) (block 702). The signal router circuit 302 further receives a first secondary cell component carrier CC₂ from the signal source circuit 304 (block 704) and a second secondary cell component carrier CC₃ from the signal source circuit 304 (block 706).

With continuing reference to FIG. 7, the signal router circuit 302 routes the component carriers CC₁-CCₘ to the one or more remote units 306(1)-306(N) according to a routing configuration of the signal router circuit 302. The controller circuit 316 controls the signal router circuit 302 for determining how many component carriers CC₁-CCₘ will be used and to which remote unit(s) 306(1)-306(N) each component carrier CC₁-CCₘ will be routed. Accordingly, the signal router circuit 302 routes the primary cell component carrier CC₁ to each of the remote units 306(1)-306(N) (block 708). The signal router circuit 302 further routes the first secondary cell component carrier CC₂ to a first remote unit 306(1) of the remote units 306(1)-306(N), but not to a second remote unit 306(2) (block 710). The signal router circuit 302 routes the second secondary cell component carrier CC₃ to the second remote unit 306(2) (block 712).

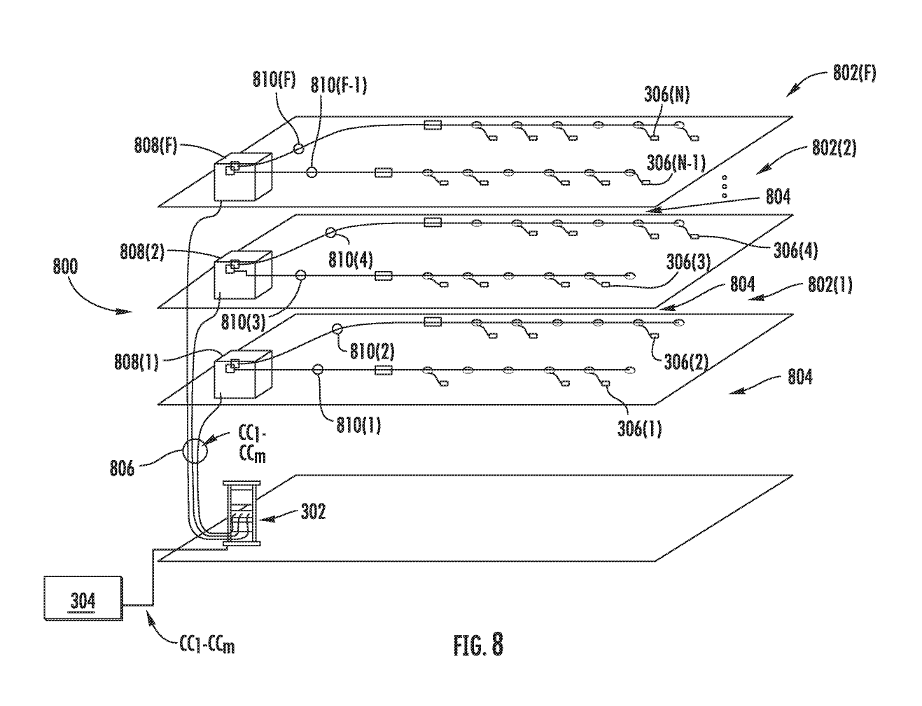

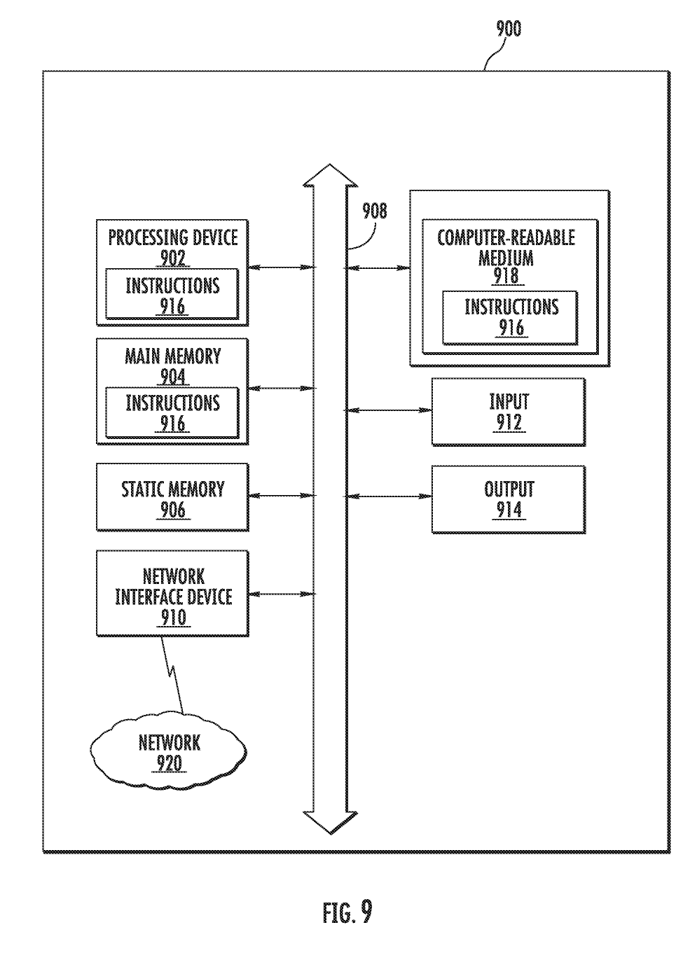

FIG. 8 is a partially schematic cut-away diagram of an exemplary building infrastructure 800 in which the distributed wireless communications system 300 of FIG. 3 can be provided. The building infrastructure 800 in this embodiment includes a first (ground) floor 802(1), a second floor 802(2), and a F^{th} floor 802(F), where ‘F’ can represent any number of floors. The floors 802(1)-802(F) are serviced by a signal router circuit 302 to provide antenna coverage areas 804 in the building infrastructure 800. The signal router circuit 302 is communicatively coupled to a signal source circuit 304, which may include some or all functions of a base transceiver station implementing carrier aggregation functionality. For example, the signal source circuit 304 may transmit and receive packetized data or other communications from a telecommunications network. The signal source circuit 304 includes circuitry implementing one or more PHY processing circuits 308(1)-308(P) (as described above with respect to FIG. 3). Each PHY processing circuit 308(1)-308(P) can generate digital signals representing a downlink baseband signal of a corresponding component carrier. Each PHY processing circuit 308(1)-308(P) may further process uplink baseband signals received from the signal router circuit 302. Accordingly, a downlink and/or uplink for a plurality of component carriers CC₁-CCₘ couple the signal source circuit 304 to the signal router circuit 302.

The signal router circuit 302 is communicatively coupled to the remote units 306(1)-306(N) and routes the component carriers CC₁-CCₘ to the remote units 306(1)-306(N) according to a routing configuration of the signal router circuit 302 as described above with respect to FIGS. 3 and 4. In some embodiments, the signal router circuit 302 is coupled to the signal source circuit 304 and the remote units 306(1)-306(N) through an optical communications link (e.g., through optical fiber cables).

The component carriers CC₁-CCₘ are distributed between the signal router circuit 302 and the remote units 306(1)-306(N) over a riser cable 806 in this example. The riser cable 806 may be routed through interconnect units (ICUs) 808(1)-808(F) dedicated to each floor 802(1)-802(F) for routing the component carriers CC₁-CCₘ to the remote units 306(1)-306(N). In addition, array cables 810(1)-810(F) may be provided and coupled between the ICUs 808(1)-808(F) that contain optical fibers to distribute the component carriers CC₁-CCₘ to the remote units 306(1)-306(N).

FIG. 9 is a schematic diagram illustrating a computer system 900 that could be employed in any component in the distributed wireless communications system 300 in FIGS. 3-8, including but not limited to the controller circuit 316, for selectively routing secondary cell component carriers CC₂-CCₘ to the remote units 306(1)-306(N). In this regard, the computer system 900 is adapted to execute instructions from an exemplary computer-readable medium to perform these and/or any of the functions or processing described herein.

In this regard, the computer system 900 in FIG. 9 may include a set of instructions that may be executed to program and configure programmable digital signal processing circuits in a distributed wireless communications system for supporting scaling of supported communications services. The computer system 900 may be connected (e.g., networked) to other machines in a LAN, an intranet, an extranet, or the Internet. While only a single device is illustrated, the term “device” shall also be taken to include any collection of devices that individually or jointly execute a set (or multiple sets) of instructions to perform any one or more of the methodologies discussed herein. The computer system 900 may be a circuit or circuits included in an electronic board card, such as, a printed circuit board (PCB), a server, a personal computer, a desktop computer, a laptop computer, a personal digital assistant (PDA), a computing pad, a mobile device, or any other device, and may represent, for example, a server or a user's computer.

The exemplary computer system 900 in this embodiment includes a processing device or processor 902, a main memory 904 (e.g., read-only memory (ROM), flash memory, dynamic random access memory (DRAM), such as synchronous DRAM (SDRAM), etc.), and a static memory 906 (e.g., flash memory, static random access memory (SRAM), etc.), which may communicate with each other via a data bus 908. Alternatively, the processor 902 may be connected to the main memory 904 and/or static memory 906 directly or via some other connectivity means. The processor 902 may be a controller circuit, and the main memory 904 or static memory 906 may be any type of memory.

The processor 902 represents one or more general-purpose processing devices, such as a microprocessor, central processing unit, or the like. More particularly, the processor 902 may be a complex instruction set computing (CISC) microprocessor, a reduced instruction set computing (RISC) microprocessor, a very long instruction word (VLIW) microprocessor, a processor implementing other instruction sets, or other processors implementing a combination of instruction sets. The processor 902 is configured to execute processing logic in instructions for performing the operations and steps discussed herein.

The computer system 900 may further include a network interface device 910. The computer system 900 also may or may not include an input 912, configured to receive input and selections to be communicated to the computer system 900 when executing instructions. The computer system 900 also may or may not include an output 914, including but not limited to a display, a video display unit (e.g., a liquid crystal display (LCD) or a cathode ray tube (CRT)), an alphanumeric input device (e.g., a keyboard), and/or a cursor control device (e.g., a mouse).

The computer system 900 may or may not include a data storage device that includes instructions 916 stored in a computer-readable medium 918. The instructions 916 may also reside, completely or at least partially, within the main memory 904 and/or within the processor 902 during execution thereof by the computer system 900, the main memory 904, and the processor 902 also constituting computer-readable medium. The instructions 916 may further be transmitted or received over a network 920 via the network interface device 910.

While the computer-readable medium 918 is shown in an exemplary embodiment to be a single medium, the term “computer-readable medium” should be taken to include a single medium or multiple media (e.g., a centralized or distributed database, and/or associated caches and servers) that store the one or more sets of instructions. The term “computer-readable medium” shall also be taken to include any medium that is capable of storing, encoding, or carrying a set of instructions for execution by the processing device and that cause the processing device to perform any one or more of the methodologies of the embodiments disclosed herein. The term “computer-readable medium” shall accordingly be taken to include, but not be limited to, solid-state memories, optical medium, and magnetic medium.

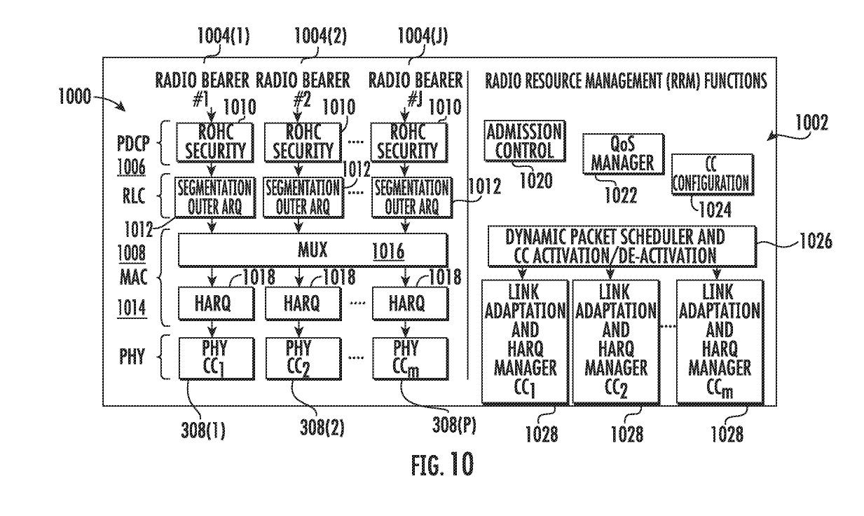

FIG. 10 is a schematic diagram illustrating an exemplary downlink user plane protocol stack 1000 for carrier aggregation and a corresponding mapping of some radio resource management functionalities 1002, some or all of which may be implemented in the distributed wireless communications system 300 of FIG. 3, such as through the signal source circuit 304. The downlink user plane protocol stack 1000 and radio resource management (RRM) functionalities 1002 represent higher layer protocols and functions of the telecommunications system, at least some of which may be implemented through the higher layer processing circuits 310 of the signal source circuit 304 depicted in FIG. 3.

With reference to FIGS. 3, 4, and 10, each mobile device 402 has at least one radio bearer (e.g., a wireless communications channel or RF carrier frequency) 1004(1)-1004(J), denoted the default radio bearer 1004(1). The mapping of data to the default radio bearer 1004(1) is up to the operator policy as configured via a traffic flow template (TFT). In addition to the default radio bearer 1004(1), mobile devices 402 may have additional radio bearers 1004(2)-1004(J) configured. There is one packet data convergence protocol (PDCP) 1006 and radio link control (RLC) 1008 per radio bearer 1004(1)-1004(J), including functionalities such as robust header compression (ROHC) 1010, security, segmentation, and outer automatic repeat request (ARQ) 1012, respectively. There is one medium access control (MAC) 1014 per mobile device 402, which controls the multiplexing (MUX) 1016 of data from all logical channels to the mobile device 402, and how this data is transmitted on the available component carriers CC₁-CCₘ. There is a separate hybrid ARQ (HARQ) entity 1018 per component carrier CC₁-CCₘ, so that data transmitted on an m^{th} component carrier CCₘ shall also be retransmitted on the same component carrier CCₘ in case prior transmission(s) are erroneous.

Generally, the interface between the MAC 1018 and PHY processing circuit 308(1)-308(P) is also separate for each component carrier CC₁-CCₘ. The transport blocks sent on different component carriers CC₁-CCₘ can be transmitted with independent modulation and coding schemes, as well as different multiple input-multiple output (MIMO) coding schemes. As a consequence, data on one component carrier CC₁-CCₘ can be transmitted with open loop transmit diversity, while data on another component carrier CC₁-CCₘ can be transmitted with dual stream closed loop precoding. Thus, there is independent link adaptation per component carrier CC₁-CCₘ to benefit from optimally matching the transmission on different component carriers CC₁-CCₘ according to the experienced radio conditions (e.g., corresponding to frequency domain link adaptation on a component carrier CC₁-CCₘ resolution).

Turning to the RRM functions 1002, admission control 1020 is performed at the signal source circuit 304 prior to establishment of new radio bearers 1004(1)-1004(J), and the corresponding quality of service (QoS) parameters are configured by the QoS manager 1022. Component carrier configuration 1024 configures a set of component carriers CC₁-CCₘ for each mobile device 402 to be distributed by the signal router circuit 302. The mobile device 402 may afterward be scheduled to communicate via the configured set of component carriers CC₁-CCₘ. The set of component carriers CC₁-CCₘ is configured to the mobile device(s) 402 with RRC signaling. The layer 2 packet scheduler (PS) 1026 is coupled with an additional functionality for dynamically activating and deactivating component carriers CC₂-CCₘ configured as secondary cells for different mobile devices 402. Secondary cell component carriers CC₂-CCₘ are activated and deactivated independently via MAC signaling 1014, while the primary cell component carrier CC₁ is not subject to deactivation. In some examples, the PS 1026 may activate and deactivate secondary cell component carriers CC₂-CCₘ as a mobile device 402 moves between coverage areas 400(1)-400(N) of different remote units 306(1)-306(N).

The dynamic PS 1026 at layer 2 is responsible for scheduling eligible mobile devices 402 on their configured and activated component carriers CC₁-CCₘ. The PS 1026 can schedule mobile devices 402 across multiple component carriers CC₁-CCₘ through independent transport blocks, link adaptation, and HARQ 1028 per component carrier CC₁-CCₘ. In some examples, the signal source circuit 304 can send a scheduling grant on one component carrier CC₁-CCₘ for scheduling the mobile device 402 on another component carrier CC₁-CCₘ, referred to as cross-CC scheduling. The cross-CC scheduling functionality is incorporated by appending a so-called carrier indicator field (CIF) to the downlink control information (DCI). The DCI is used to indicate the mobile device 402 allocations for uplink and downlink traffic, and the CIF is used to address on which component carrier CC₁-CCₘ the mobile device 402 data is transmitted. In some examples, cross-CC scheduling may be used through the primary cell component carrier CC₁ to activate/deactivate and schedule the secondary cell component carriers CC₁-CCₘ.

It will be apparent to those skilled in the art that various modifications and variations can be made without departing from the spirit or scope of the invention.

The embodiments disclosed herein include various steps. The steps of the embodiments disclosed herein may be formed by hardware components or may be embodied in machine-executable instructions, which may be used to cause a general-purpose or special-purpose processor programmed with the instructions to perform the steps. Alternatively, the steps may be performed by a combination of hardware and software.

The embodiments disclosed herein may be provided as a computer program product, or software, that may include a machine-readable medium (or computer-readable medium) having stored thereon instructions, which may be used to program a computer system (or other electronic devices) to perform a process according to the embodiments disclosed herein. A machine-readable medium includes any mechanism for storing or transmitting information in a form readable by a machine (e.g., a computer). For example, a machine-readable medium includes: a machine-readable storage medium (e.g., ROM, random access memory (“RAM”), a magnetic disk storage medium, an optical storage medium, flash memory devices, etc.); and the like.

Unless specifically stated otherwise and as apparent from the previous discussion, it is appreciated that throughout the description, discussions utilizing terms such as “processing,” “computing,” “determining,” “displaying,” or the like, refer to the action and processes of a computer system, or similar electronic computing device, that manipulates and transforms data and memories represented as physical (electronic) quantities within the computer system's registers into other data similarly represented as physical quantities within the computer system memories or registers or other such information storage, transmission, or display devices.

The algorithms and displays presented herein are not inherently related to any particular computer or other apparatus. Various systems may be used with programs in accordance with the teachings herein, or it may prove convenient to construct more specialized apparatuses to perform the required method steps. The required structure for a variety of these systems will appear from the description above. In addition, the embodiments described herein are not described with reference to any particular programming language. It will be appreciated that a variety of programming languages may be used to implement the teachings of the embodiments as described herein.

Those of skill in the art will further appreciate that the various illustrative logical blocks, modules, circuits, and algorithms described in connection with the embodiments disclosed herein may be implemented as electronic hardware, instructions stored in memory or in another computer-readable medium and executed by a processor or other processing device, or combinations of both. The components of the distributed wireless communications systems described herein may be employed in any circuit, hardware component, integrated circuit (IC), or IC chip, as examples. Memory disclosed herein may be any type and size of memory and may be configured to store any type of information desired. To clearly illustrate this interchangeability, various illustrative components, blocks, modules, circuits, and steps have been described above generally in terms of their functionality. How such functionality is implemented depends on the particular application, design choices, and/or design constraints imposed on the overall system. Skilled artisans may implement the described functionality in varying ways for each particular application, but such implementation decisions should not be interpreted as causing a departure from the scope of the present embodiments.

The various illustrative logical blocks, modules, and circuits described in connection with the embodiments disclosed herein may be implemented or performed with a processor, a Digital Signal Processor (DSP), an Application Specific Integrated Circuit (ASIC), a Field Programmable Gate Array (FPGA), or other programmable logic device, a discrete gate or transistor logic, discrete hardware components, or any combination thereof designed to perform the functions described herein. Furthermore, a controller circuit may be a processor. A processor may be a microprocessor, but in the alternative, the processor may be any conventional processor, controller, microcontroller, or state machine. A processor may also be implemented as a combination of computing devices (e.g., a combination of a DSP and a microprocessor, a plurality of microprocessors, one or more microprocessors in conjunction with a DSP core, or any other such configuration).

The embodiments disclosed herein may be embodied in hardware and in instructions that are stored in hardware, and may reside, for example, in RAM, flash memory, ROM, Electrically Programmable ROM (EPROM), Electrically Erasable Programmable ROM (EEPROM), registers, a hard disk, a removable disk, a CD-ROM, or any other form of computer-readable medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a remote station. In the alternative, the processor and the storage medium may reside as discrete components in a remote station, base station, or server.

It is also noted that the operational steps described in any of the exemplary embodiments herein are described to provide examples and discussion. The operations described may be performed in numerous different sequences other than the illustrated sequences. Furthermore, operations described in a single operational step may actually be performed in a number of different steps. Additionally, one or more operational steps discussed in the exemplary embodiments may be combined. Those of skill in the art will also understand that information and signals may be represented using any of a variety of technologies and techniques. For example, data, instructions, commands, information, signals, bits, symbols, and chips, that may be references throughout the above description, may be represented by voltages, currents, electromagnetic waves, magnetic fields, or particles, optical fields or particles, or any combination thereof.

Unless otherwise expressly stated, it is in no way intended that any method set forth herein be construed as requiring that its steps be performed in a specific order. Accordingly, where a method claim does not actually recite an order to be followed by its steps, or it is not otherwise specifically stated in the claims or descriptions that the steps are to be limited to a specific order, it is in no way intended that any particular order be inferred.

What is claimed is:

1. A distributed wireless communications system, comprising:
a signal router circuit, comprising:
a plurality of signal source inputs each configured to receive a component carrier among a plurality of component carriers, the plurality of component carriers comprising a primary cell component carrier, a first secondary cell component carrier, and a second secondary cell component carrier;
a plurality of signal outputs each configured to couple to a remote unit among a plurality of remote units; and
a routing control input configured to receive a routing control signal indicating a routing configuration for routing the primary cell component carrier, the first secondary cell component carrier, and the second secondary cell component carrier to the plurality of signal outputs; and
a controller circuit comprising a routing control output coupled to the routing control input, the controller circuit configured to communicate the routing control signal indicating the routing configuration for:
routing the primary cell component carrier to each of the plurality of signal outputs;
routing the first secondary cell component carrier to a first subset of the plurality of signal outputs less than all of the plurality of signal outputs; and
routing the second secondary cell component carrier to a second subset of the plurality of signal outputs less than all of the plurality of signal outputs; wherein the first subset of the plurality of signal outputs includes at least one signal output not included in the second subset of the plurality of signal outputs.

2. The distributed wireless communications system of claim 1, further comprising the plurality of remote units each coupled to a corresponding signal output of the plurality of signal outputs.

3. The distributed wireless communications system of claim 2, wherein in response to receiving the routing configuration from the controller circuit, the signal router circuit is configured to:
route the primary cell component carrier over each of the plurality of signal outputs to each of the plurality of remote units;
route the first secondary cell component carrier over the first subset of the plurality of signal outputs to a corresponding first subset of the plurality of remote units; and
route the second secondary cell component carrier over the second subset of the plurality of signal outputs to a corresponding second subset of the plurality of remote units.

4. The distributed wireless communications system of claim 3, wherein:
the plurality of signal source inputs are each configured to receive the component carrier among the plurality of component carriers in baseband; and
the signal router circuit is further configured to route the primary cell component carrier, the first secondary cell component carrier, and the second secondary cell component carrier in baseband.

5. The distributed wireless communications system of claim 4, wherein each remote unit of the plurality of remote units is configured to transmit the primary cell component carrier on a wireless channel.

6. The distributed wireless communications system of claim 3, wherein:
each of the plurality of remote units is configured to transmit the primary cell component carrier on a first wireless channel;
the first subset of the plurality of remote units is configured to transmit the first secondary cell component carrier on a second wireless channel; and
the second subset of the plurality of remote units is configured to transmit the second secondary cell component carrier on the second wireless channel.

7. The distributed wireless communications system of claim 2, wherein the plurality of remote units are each coupled to the corresponding signal output via an optical communications link.

8. The distributed wireless communications system of claim 1, further comprising a signal source circuit coupled to the plurality of signal source inputs of the signal router circuit.

9. The distributed wireless communications system of claim 8, wherein the signal source circuit comprises a plurality of physical layer processing circuits each coupled to a corresponding signal source input of the plurality of signal source inputs, each of the plurality of physical layer processing circuits configured to generate a respective component carrier of the plurality of component carriers.

10. The distributed wireless communications system of claim 9, wherein:
the signal source circuit is configured to transmit and receive packetized data from a telecommunications network; and
each of the plurality of physical layer processing circuits generates the respective component carrier by converting a portion of the packetized data to a baseband signal.

11. The distributed wireless communications system of claim 9, further comprising the plurality of remote units each coupled to a corresponding signal output of the plurality of signal outputs;
wherein:
each of the plurality of physical layer processing circuits generates the respective component carrier in baseband; and
each remote unit of the plurality of remote units is configured to transmit the primary cell component carrier on a wireless channel.

12. The distributed wireless communications system of claim 1, further comprising the plurality of remote units each coupled to a corresponding signal output of the plurality of signal outputs by an optical fiber communications link;
wherein:
each of the plurality of signal outputs comprises an electrical-to-optical (E-O) converter configured to transmit a respective optical communications signal by the optical fiber communications link according to the routing configuration for the plurality of component carriers; and
each remote unit of the plurality of remote units comprises an optical-to-electrical (O-E) converter configured to convert the respective optical communications signal into a respective electrical communications signal to interface with an RF transmitter/receiver.

13. The distributed wireless communications system of claim 8, further comprising an optical link coupling the signal source circuit to the plurality of signal source inputs.

14. The distributed wireless communications system of claim 1, wherein the primary cell component carrier comprises:
an uplink configured to transmit data from a mobile device to a telecommunications network; and
a downlink configured to transmit data from the telecommunications network to the mobile device.

15. The distributed wireless communications system of claim 1, wherein each of the first secondary cell component carrier and the second secondary cell component carrier comprises a downlink configured to transmit data from a telecommunications network to a mobile device.

16. The distributed wireless communications system of claim 15, wherein the first secondary cell component carrier further comprises an uplink configured to transmit data from the mobile device to the telecommunications network.

17. The distributed wireless communications system of claim 1, wherein:
the plurality of signal outputs is a first plurality of signal outputs;
the primary cell component carrier is a first primary cell component carrier;
the signal router circuit further comprises a second plurality of signal outputs; and
the controller circuit is further configured to communicate the routing control signal indicating the routing configuration for routing the second primary cell component carrier to each of the second plurality of signal outputs.

18. A method for selectively routing primary cell and secondary cell component carriers from one or more signal source circuits to a plurality of remote units in a distributed wireless communications system, comprising:
receiving a primary cell component carrier;
receiving a first secondary cell component carrier;
receiving a second secondary cell component carrier;
routing the primary cell component carrier to each of the plurality of remote units;
routing the first secondary cell component carrier to a first remote unit and not to a second remote unit of the plurality of remote units; and
routing the second secondary cell component carrier to the second remote unit.

19. The method of claim 18, wherein:
the primary cell component carrier is received and routed in baseband;
the first secondary cell component carrier is received and routed in baseband; and
the second secondary cell component carrier is received and routed in baseband.

20. The method of claim 19, further comprising:
transmitting a first downlink for the primary cell component carrier on a first wireless channel via each of the plurality of remote units; and
receiving an uplink for the primary cell component carrier on the first wireless channel via at least one of the plurality of remote units.

21. The method of claim 20, further comprising:
transmitting a second downlink for the first secondary cell component carrier on a second wireless channel via the first remote unit; and
transmitting a third downlink for the second secondary cell component carrier on the second wireless channel via the second remote unit.

22. The method of claim 18, further comprising:
receiving packetized data at a signal source circuit; and
converting at least a portion of the packetized data to generate the primary cell component carrier, the first secondary cell component carrier, and the second secondary cell component carrier;
wherein the primary cell component carrier, the first secondary cell component carrier, and the second secondary cell component carrier are received from the signal source circuit.

23. The method of claim 18, wherein the receiving the primary cell component carrier comprises:
establishing a downlink with a telecommunications network, the downlink receiving data to be transmitted to a mobile device; and
establishing an uplink with the telecommunications network, the uplink transmitting data to the telecommunications network.

24. The method of claim 23, wherein the receiving the first secondary cell component carrier comprises establishing a second downlink with the telecommunications network without establishing a second uplink with the telecommunications network.
